(19) United States
(12) Patent Application Publication
(10) Pub. No.: US 2024/0203376 A1
(43) Pub. Date: Jun. 20, 2024

(54) EFFICIENTLY PROCESSING MULTIPLE NON-OVERLAPPING LAYER IMAGES IN DISPLAY PROCESSING UNITS

(71) Applicant: QUALCOMM Incorporated, San Diego, CA (US)

(72) Inventors: Sreekanth Modaikkal, Bangalore (IN); Kumar Saurabh, Bangalore (IN); Gary Arthur Ciambella, Newmarket (CA); Chun Wang, Markham (CA); Anitha Madugiri Siddaraju, Bangalore (IN)

(21) Appl. No.: 18/066,034

(22) Filed: Dec. 14, 2022

(51) Int. Cl. G09G 5/14; G06T 1/60; G09G 5/397

(52) U.S. Cl. CPC G09G 5/14; G06T 1/60; G09G 5/397; G09G 2340/10; G09G 2340/12

(57) ABSTRACT

Efficiently processing multiple non-overlapping layer images in display processing units is disclosed herein. In this regard, in some exemplary aspects, a display processing unit comprising a plurality of memory access pipeline circuits and a layer mixer circuit is provided. For each non-overlapping layer image of a plurality of non-overlapping layer images, a memory access pipeline circuit obtains image configuration data for the non-overlapping layer image, and fetches the non-overlapping layer image from an image data storage device based on the image configuration data. The memory access pipeline circuit then outputs each pixel of the non-overlapping layer image as part of an intermediate preblend image data stream based on the image configuration data. The layer mixer circuit blends the intermediate preblend image data stream and a background layer image data stream comprising a background layer image as a display data stream, and outputs the display data stream to a display device.

### BACKGROUND

### I. Field of the Disclosure

The technology of the disclosure relates generally to display processing units in processor-based devices, and, in particular, to processing and blending layer images for display.

### II. Background

Modern processor-based devices may include a dedicated processing unit, known as a display processing unit, to handle operations for fetching, processing, and blending image data for display on a display device. A conventional display processing unit comprises multiple memory access pipelines, each of which includes, e.g., a fetch circuit that retrieves image data from memory or other image data storage device, as well as a pixel processing unit that performs image processing (e.g., color correction operations, zoom operation, scaling operations, and the like) on the image data. The image data is then fed by each memory access pipeline to a layer mixer circuit that performs blending of multiple layer images, and further to a pixel processing unit that performs display-specific image processing operations. Finally, the blended and processed image data is sent to a display device for display to a user.

One task commonly performed by a display processing unit is the fetching and blending of multiple non-overlapping layer images with a background layer image. In conventional display processing units, each memory access pipeline is configured to fetch a single non-overlapping layer image. Blending multiple non-overlapping layer images with a background layer image thus requires the use of multiple memory access pipelines, one for the background layer image and one for each non-overlapping layer image. Consequently, the number of non-overlapping images that can be blended by a display processing unit is limited by the number of memory access pipelines provided by the display processing unit.

### SUMMARY OF THE DISCLOSURE

Aspects disclosed in the detailed description include efficiently processing multiple non-overlapping layer images in display processing units. Related apparatus, methods, and computer-readable media are also disclosed. In this regard, in some exemplary aspects disclosed herein, a display processing unit provides a plurality of memory access pipeline circuits and a layer mixer circuit. A first memory access pipeline circuit is configured to fetch and preblend a plurality of non-overlapping layer images (i.e., layer images whose position and dimensions do not overlap) into an intermediate preblend image, which is then blended by the layer mixer circuit with a background layer image fetched by a second memory access pipeline. To generate the intermediate preblend image, the first memory access pipeline performs a series of operations for each of the non-overlapping layer images. The first memory access pipeline first obtains image configuration data for the non-overlapping layer image, then fetches the non-overlapping layer image from an image data storage device based on the image configuration data. The first memory access pipeline next outputs each pixel of the non-overlapping layer image as part of the intermediate preblend image to an intermediate preblend image data stream based on the image configuration data. Upon receiving the intermediate preblend image data stream from the first memory access pipeline and a background image data stream from the second memory access pipeline, the layer mixer circuit blends the intermediate preblend image data stream and the background layer image data stream as a display data stream. The display data stream may then be transmitted to a display device for display to a user.

In some aspects, the first memory access pipeline circuit may comprise a plurality of image configuration registers, which may receive the image configuration data from, e.g., an executing software process, and which may be used to populate an image configuration queue. The first memory access pipeline circuit may then obtain the image configuration data for each non-overlapping layer image from a top entry in the image configuration queue (e.g., by “popping” the image configuration for each non-overlapping layer image from the image configuration queue). According to some aspects, the first memory access pipeline circuit may calculate a set of position coordinates and a size of the intermediate preblend image to be generated, based on the image configuration data received for the plurality of non-overlapping layer images. The first memory access pipeline circuit may then transmit the set of position coordinates and the size of the intermediate preblend image to the layer mixer circuit for use in blending the intermediate preblend image data stream and the background layer image data stream. In some aspects, the first memory access pipeline circuit may comprise two (2) image configuration queues, such that the first memory access pipeline circuit may obtain image configuration data from a first image configuration queue while receiving, in parallel, image configuration data for a next set of non-overlapping layer images into the second image configuration queue.

Some aspects may provide that, as part of outputting each pixel of the non-overlapping layer image to the intermediate preblend image data stream, the first memory access pipeline circuit may output a blend bypass pixel (e.g., a pixel having a pre-specified color value) for each pixel of the intermediate preblend image that does not correspond to a pixel of the non-overlapping layer image. When the layer mixer circuit subsequently blends the intermediate preblend image data stream and the background layer image data stream, the layer mixer circuit may blend each pixel of the intermediate preblend image data stream that corresponds to a non-overlapping layer with a corresponding pixel of the background layer image. The layer mixer circuit may also output a corresponding pixel of the background layer image for each blend bypass pixel of the intermediate preblend image data stream.

In some aspects, the layer mixer circuit may employ multiple blending stages to blend images from multiple memory access pipeline circuits. According to such aspects, each blending stage corresponds to a memory access pipeline circuit of the plurality of memory access pipeline circuits, and the layer mixer circuit outputs the display data stream of each blending stage preceding the final blending stage as the background layer image data stream to a successive blending stage. The layer mixer circuit then outputs the display data stream of the final blending stage to the display device. Some such aspects may enable the first memory access pipeline circuit to send image data to one or more blending stages by providing a layer mixer configuration queue, into which the layer mixer circuit receives a memory access pipeline identifier and a blending stage indication for the first memory access pipeline circuit. The layer mixer circuit assigns a tag corresponding to the layer mixer configuration queue to the first memory access pipeline circuit based on the memory access pipeline identifier, thereby associating the layer mixer configuration queue with the first memory access pipeline. Upon receiving the intermediate preblend image data stream from the first memory access pipeline circuit, the layer mixer circuit obtains the memory access pipeline identifier and the blending stage indication from the layer mixer configuration queue based on the tag, and blends the intermediate preblend image data stream and the background layer image data stream in the appropriate blending stage based on the blending stage indication.

In another aspect, a display processing unit is provided. The display processing unit comprises a plurality of memory access pipeline circuits and a layer mixer circuit. A first memory access pipeline circuit of the plurality of memory access pipeline circuits is configured to, for each non-overlapping layer image of a plurality of non-overlapping layer images, obtain image configuration data for the non-overlapping layer image. The first memory access pipeline circuit is further configured fetch the non-overlapping layer image from an image data storage device based on the image configuration data. The first memory access pipeline circuit is also configured to output each pixel of the non-overlapping layer image as part of an intermediate preblend image to an intermediate preblend image data stream based on the image configuration data. The layer mixer circuit is configured to blend the intermediate preblend image data stream and a background layer image data stream comprising a background layer image as a display data stream. The layer mixer circuit is further configured to output the display data stream to a display device.

In another aspect, a display processing unit is provided. The display processing unit comprises means for, for each non-overlapping layer image of a plurality of non-overlapping layer images, obtaining image configuration data for the non-overlapping layer image, fetching the non-overlapping layer image from an image data storage device based on the image configuration data, and outputting each pixel of the non-overlapping layer image as part of an intermediate preblend image to an intermediate preblend image data stream based on the image configuration data. The display processing unit further comprises means for blending the intermediate preblend image data stream and a background layer image data stream comprising a background layer image as a display data stream. The display processing unit also comprises means for outputting the display data stream to a display device.

In another aspect, a method for efficiently processing multiple non-overlapping layer images is provided. The method comprises, for each non-overlapping layer image of a plurality of non-overlapping layer images, obtaining, by a first memory access pipeline circuit of a display processing unit, image configuration data for the non-overlapping layer image. The method further comprises fetching, by the first memory access pipeline circuit, the non-overlapping layer image from an image data storage device based on the image configuration data. The method also comprises outputting, by the first memory access pipeline circuit, each pixel of the non-overlapping layer image as part of an intermediate preblend image to an intermediate preblend image data stream based on the image configuration data. The method additionally comprises blending, by a layer mixer circuit of the display processing unit, the intermediate preblend image data stream and a background layer image data stream as a display data stream. The method further comprises outputting, by the layer mixer circuit, the display data stream to a display device.

### BRIEF DESCRIPTION OF THE FIGURES

FIG. 1 is a block diagram of an exemplary processor-based device that includes a display processing unit that is configured to efficiently process multiple non-overlapping layer images, according to some aspects;

FIG. 2 is a diagram illustrating the use of multiple display pipelines in conventional display processing units to blend multiple non-overlapping layer images and a background layer image, according to some aspects;

FIG. 3 is a diagram illustrating a processing timeline of a conventional display processing unit when blending the multiple non-overlapping layer images and the background layer image of FIG. 2, according to some aspects;

FIG. 4 is a block diagram illustrating in greater detail the memory access pipeline circuit and the layer mixer circuit of the display processing unit of FIG. 1 for efficiently processing multiple non-overlapping layer images, according to some aspects;

FIG. 5 is a diagram illustrating the use of a single display pipeline in the display processing unit of FIGS. 1 and 4 to blend multiple non-overlapping layer images into an intermediate preblend image, which is then blended with a background layer image, according to some aspects;

FIG. 6 is a diagram illustrating a processing timeline of the display processing unit of FIGS. 1 and 4 when blending the multiple non-overlapping layer images and the background layer image of FIG. 5, according to some aspects;

FIG. 7 is a diagram illustrating the use of blending stages by the display processing unit of FIGS. 1 and 4 when blending images provided by multiple memory access pipeline circuits, according to some aspects;

FIGS. 8A-8C provide a flowchart illustrating exemplary operations for efficiently processing multiple non-overlapping layer images, according to some aspects;

FIGS. 9A and 9B provide a flowchart illustrating exemplary operations performed by the layer mixer circuit of FIGS. 1 and 4 for blending images from multiple memory access pipeline circuits using blending stages, according to some aspects; and

FIG. 10 is a block diagram of an exemplary processor-based device that can include the display processing unit of FIGS. 1 and 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include efficiently processing multiple non-overlapping layer images in display processing units. Related apparatus, methods, and computer-readable media are also disclosed. In this regard, in some exemplary aspects disclosed herein, a display processing unit provides a plurality of memory access pipeline circuits and a layer mixer circuit. A first memory access pipeline circuit is configured to fetch and preblend a plurality of non-overlapping layer images (i.e., layer images whose position and dimensions do not overlap) into an intermediate preblend image, which is then blended by the layer mixer circuit with a background layer image fetched by a second memory access pipeline. To generate the intermediate preblend image, the first memory access pipeline performs a series of operations for each of the non-overlapping layer images. The first memory access pipeline first obtains image configuration data for the non-overlapping layer image, then fetches the non-overlapping layer image from an image data storage device based on the image configuration data. The first memory access pipeline next outputs each pixel of the non-overlapping layer image as part of the intermediate preblend image to an intermediate preblend image data stream based on the image configuration data. Upon receiving the intermediate preblend image data stream from the first memory access pipeline and a background image data stream from the second memory access pipeline, the layer mixer circuit blends the intermediate preblend image data stream and the background layer image data stream as a display data stream. The display data stream may then be transmitted to a display device for display to a user.

In some aspects, the first memory access pipeline circuit may comprise a plurality of image configuration registers, which may receive the image configuration data from, e.g., an executing software process, and which may be used to populate an image configuration queue. The first memory access pipeline circuit may then obtain the image configuration data for each non-overlapping layer image from a top entry in the image configuration queue (e.g., by “popping” the image configuration for each non-overlapping layer image from the image configuration queue). According to some aspects, the first memory access pipeline circuit may calculate a set of position coordinates and a size of the intermediate preblend image to be generated, based on the image configuration data received for the plurality of non-overlapping layer images. The first memory access pipeline circuit may then transmit the set of position coordinates and the size of the intermediate preblend image to the layer mixer circuit for use in blending the intermediate preblend image data stream and the background layer image data stream. In some aspects, the first memory access pipeline circuit may comprise two (2) image configuration queues, such that the first memory access pipeline circuit may obtain image configuration data from a first image configuration queue while receiving, in parallel, image configuration data for a next set of non-overlapping layer images into the second image configuration queue.

Some aspects may provide that, as part of outputting each pixel of the non-overlapping layer image to the intermediate preblend image data stream, the first memory access pipeline circuit may output a blend bypass pixel (e.g., a pixel having a pre-specified color value) for each pixel of the intermediate preblend image that does not correspond to a pixel of the non-overlapping layer image. When the layer mixer circuit subsequently blends the intermediate preblend image data stream and the background layer image data stream, the layer mixer circuit may blend each pixel of the intermediate preblend image data stream that corresponds to a non-overlapping layer with a corresponding pixel of the background layer image. The layer mixer circuit may also output a corresponding pixel of the background layer image for each blend bypass pixel of the intermediate preblend image data stream.

In some aspects, the layer mixer circuit may employ multiple blending stages to blend images from multiple memory access pipeline circuits. According to such aspects, each blending stage corresponds to a memory access pipeline circuit of the plurality of memory access pipeline circuits, and the layer mixer circuit outputs the display data stream of each blending stage preceding the final blending stage as the background layer image data stream to a successive blending stage. The layer mixer circuit then outputs the display data stream of the final blending stage to the display device. Some such aspects may enable the first memory access pipeline circuit to send image data to one or more blending stages by providing a layer mixer configuration queue, into which the layer mixer circuit receives a memory access pipeline identifier and a blending stage indication for the first memory access pipeline circuit. The layer mixer circuit assigns a tag corresponding to the layer mixer configuration queue to the first memory access pipeline circuit based on the memory access pipeline identifier, thereby associating the layer mixer configuration queue with the first memory access pipeline. Upon receiving the intermediate preblend image data stream from the first memory access pipeline circuit, the layer mixer circuit obtains the memory access pipeline identifier and the blending stage indication from the layer mixer configuration queue based on the tag, and blends the intermediate preblend image data stream and the background layer image data stream in the appropriate blending stage based on the blending stage indication.

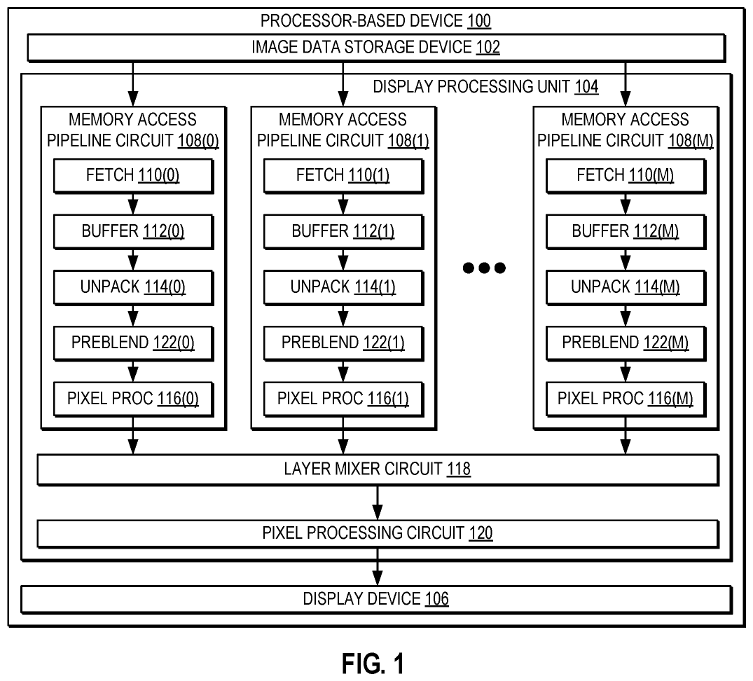

In this regard, FIG. 1 is a diagram of an exemplary processor-based device 100 that includes an image data storage device 102, a display processing unit 104, and a display device 106. The image data storage device 102 may comprise any data storage device on which image data is stored, and in some aspects may comprise Double Data Rate (DDR) memory, as a non-limiting example. The image data storage device 102 in some aspects may be communicatively coupled to the display processing unit 104 via a Network-on-Chip (NOC), which is not shown in FIG. 1 for the sake of clarity. The display processing unit 104 of the processor-based device 100 is configured to handle operations for fetching, processing, and blending image data for display on the display device 106. The display device 106 according to some aspects may comprise any type of display, including but not limited to a cathode ray tube (CRT) device, a liquid crystal display (LCD) device, a plasma display device, and the like. It is to be understood that, while the display device 106 is illustrated in FIG. 1 as an integral element of the processor-based device 100, some aspects may provide that the display device 106 comprises a peripheral that is communicatively coupled to, but separate from, the processor-based device 100.

The display processing unit 104 of FIG. 1 includes multiple memory access pipeline circuits 108(0)-108(M), each of which is configured to fetch image data (not shown) from the image data storage device 102, perform image processing operations on the image data, and provide the processed image data to a layer mixer circuit 118 for mixing and blending. The memory access pipeline circuits 108(0)-108(M) comprise corresponding fetch circuits (captioned as “FETCH” in FIG. 1) 110(0)-110(M), buffers (captioned as “BUFFER” in FIG. 1) 112(0)-112(M), unpack circuits (captioned as “UNPACK” in FIG. 1) 114(0)-114(M), and pixel processing circuits (captioned as “PIXEL PROC” in FIG. 1) 116(0)-116(M). In conventional operation, the fetch circuits 110(0)-110(M) are configured to retrieve image data for images from the image data storage device 102, and store the retrieved image data in the corresponding buffers 112(0)-112(M). The unpack circuits 114(0)-114(M) are configured to receive image data streams from the corresponding buffers 112(0)-112(M), and to process the image data streams to obtain, e.g., information regarding rows and columns of each image and alpha/red/green/blue (ARGB) data for each pixel of each image. The pixel processing circuits 116(0)-116(M) are configured to then perform additional processing on the image data streams, such as color correction, zooming, upscaling/downscaling, and/or the like, as non-limiting examples. The layer mixer circuit 118 is configured to receive image data streams from the pixel processing circuits 116(0)-116(M), and to blend the image data streams into a single display data stream. The resulting display data stream is then sent to a pixel processing circuit 120 for additional display-specific processing, and finally is sent to the display device 106 for display.

The processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor-based device 100 may include elements in addition to those illustrated in FIG. 1, and/or may include more or fewer of the elements illustrated in FIG. 1. For example, the processor-based device 100 may further include one or more buffers, caches, controllers, and/or communications buses, which are omitted from FIG. 1 for the sake of clarity.

As noted above, one task commonly performed by conventional display processing units is the fetching and blending of multiple non-overlapping layer images with a background layer image. Because memory access pipelines in conventional display processing units are each configured to fetch a single non-overlapping layer image, the blending of multiple non-overlapping layer images with a background layer image requires the use of multiple memory access pipelines (i.e., one for the background layer image and one for each non-overlapping layer image). As a result, the number of non-overlapping images that can be blended is limited by the number of memory access pipelines that are provided by the display processing unit.

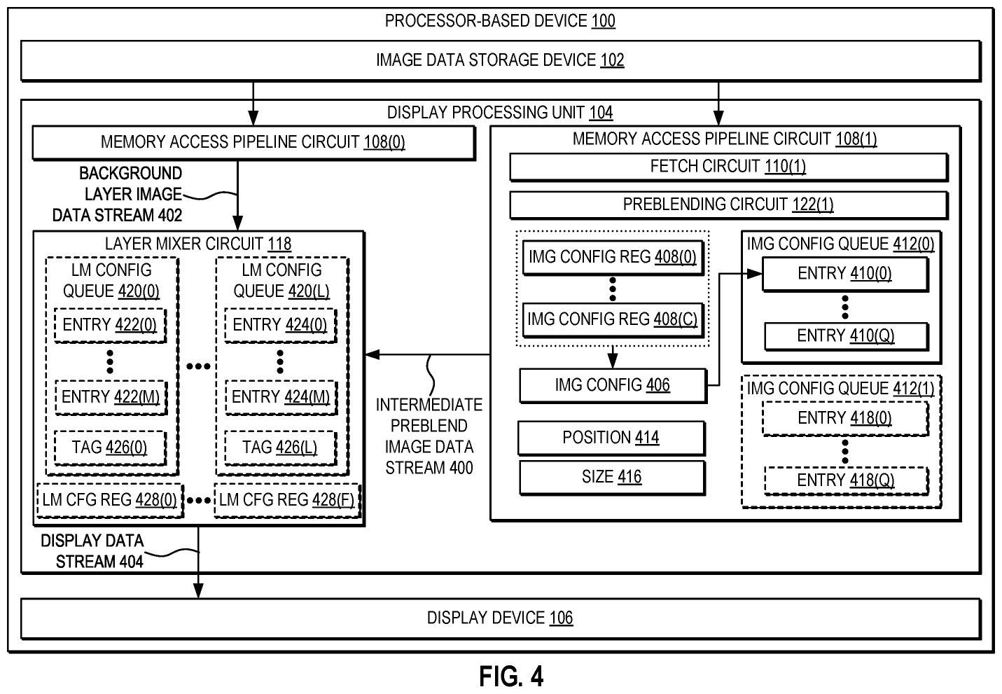

Accordingly, to efficiently process multiple non-overlapping layer images, the memory access pipeline circuits 108(0)-108(M) of the display processing unit 104 of FIG. 1 are each configured to retrieve multiple non-overlapping layer images and generate an intermediate preblend layer image that includes the multiple non-overlapping layer images. In particular, each of the fetch circuits 110(0)-110(M) is configured to dynamically fetch multiple non-overlapping layer images from the image data storage device 102 based on image configuration data provided, e.g., by an executing software process (not shown). In addition, each memory access pipeline circuit 108(0)-108(M) further provides a corresponding preblending circuit (captioned as “PREBLEND” in FIG. 1) 122(0)-122(M) that is configured to combine the non-overlapping layer images into an intermediate preblend layer image that can then be sent to the layer mixer circuit 118 for blending with a background layer image. The operations performed by the memory access pipeline circuits 108(0)-108(M) and the layer mixer circuit 118 of FIG. 1 for efficiently processing multiple non-overlapping layer images are discussed in greater detail below with respect to FIG. 4.

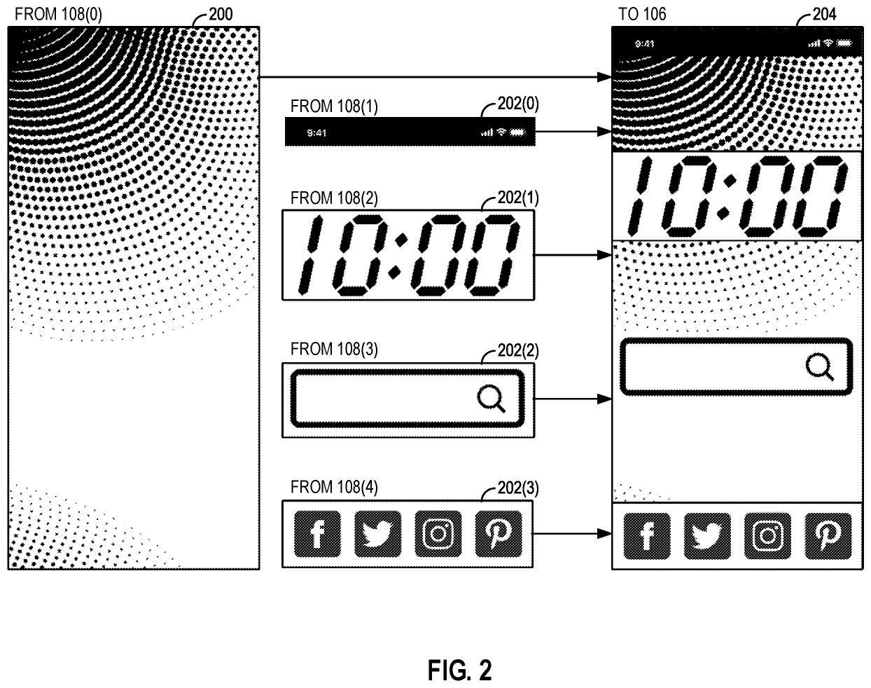

Before describing the memory access pipeline circuits 108(0)-108(M) and the layer mixer circuit 118 of FIG. 1 in greater detail, the use of multiple display pipelines in conventional display processing units to blend multiple non-overlapping layer images and a background layer image is first described for purpose of comparison. In this regard, FIG. 2 illustrates a background layer image 200 and four (4) non-overlapping layer images 202(0)-202(3) that are to be combined into a final blended image 204 for display on a display device such as the display device 106 of FIG. 1. Assuming the display processing unit 104 of FIG. 1 was operating in conventional fashion, each of the background layer image 200 and the non-overlapping layer images 202(0)-202(3) would be fetched by separate ones of the memory access pipeline circuits 108(0)-108(M) of FIG. 1 (assuming that M≥4). Thus, in the example of FIG. 1, the background layer image 200 is fetched and processed by the memory access pipeline circuit 108(0), the non-overlapping layer image 202(0) is fetched by the memory access pipeline circuit 108(1), the non-overlapping layer image 202(1) is fetched by a memory access pipeline circuit 108(2) (not shown in FIG. 1), the non-overlapping layer image 202(2) is fetched by a memory access pipeline circuit 108(3) (not shown in FIG. 1), and the non-overlapping layer image 202(3) is fetched by a memory access pipeline circuit 108(4) (not shown in FIG. 1). Image data streams for the background layer image 200 and the non-overlapping layer images 202(0)-202(3) are then sent to the layer mixer circuit 118, which blend the image data streams into a final blended image 204.

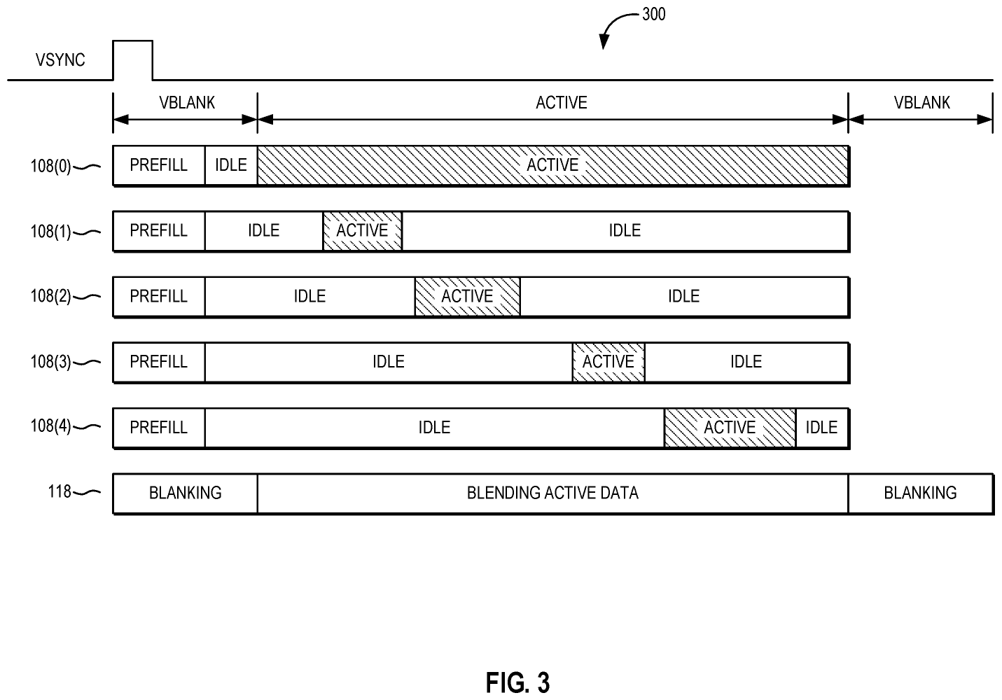

The operation of conventional display processing units when blending multiple non-overlapping layer images and a background layer image as described in FIG. 2 results in all of the memory access pipeline circuits 108(0)-108(4) being employed for the duration of the generation of the final blended image 204, even though each of the memory access pipeline circuits 108(1)-108(4) only supply a small portion of the final blended image 204. This is illustrated by a processing timeline 300 shown in FIG. 3. The processing timeline 300 shows the activity of the memory access pipeline circuits 108(0)-108(4) and the layer mixer circuit 118 of FIG. 1, operating in conventional fashion as described above with respect to FIG. 2, during one display screen refresh cycle.

In FIG. 3, the caption “VSYNC” indicates the beginning of vertical synchronization, while the captions “VBLANK” and “BLANKING” indicate periods of time during which image data is not being transmitted to the display device 106 by the layer mixer circuit 118 (e.g., via the pixel processing circuit 120 of FIG. 1). The caption “PREFILL” in FIG. 3 indicates periods of time during which each of the memory access pipeline circuits 108(0)-108(4) is fetching and filling corresponding buffers 112(0)-112(4), while the caption “IDLE” indicates periods of time during which each of the memory access pipeline circuits 108(0)-108(4) is waiting to transmit image data streams to the layer mixer circuit 118. Finally, in FIG. 3, the caption “ACTIVE” indicates periods of time during which each of the memory access pipeline circuits 108(0)-108(4) is actively processing and transmitting an image data stream to the layer mixer circuit 118, and the caption “BLENDING ACTIVE DATA” indicates the period of time during which the layer mixer circuit 118 is blending image data streams and transmitting a display data stream to the display device 106.

As seen in FIG. 3, the memory access pipeline circuit 108(0), which is processing and transmitting the background layer image data stream for the background layer image 200 of FIG. 2, is active during the entire time that the layer mixer circuit 118 is blending image data streams and transmitting the display data stream to the display device 106. Each of the memory access pipeline circuits 108(1)-108(4), however, is active only during relatively brief periods that approximately correspond in position and duration to the position and size of the associated non-overlapping layer images 202(0)-202(3) of FIG. 2. Conventional processing of multiple non-overlapping layer images thus can be considered to be inefficient both because each of the memory access pipeline circuits can fetch only a single layer image (i.e., the background layer image or a single non-overlapping layer image), and also because each of the memory access pipeline circuits that process the non-overlapping layer images are only utilized for a small portion of time relative to the total time required to generate the final display data stream.

Accordingly, FIG. 4 illustrates in greater detail the memory access pipeline circuits 108(0) and 108(1) and the layer mixer circuit 118 of FIG. 1 for efficiently processing multiple non-overlapping layer images, according to some aspects. FIG. 4 shows the processor-based device 100, comprising the image data storage device 102, the display processing unit 104, and the display device 106, of FIG. 1. The memory access pipeline circuits 108(0) and 108(1) and the layer mixer circuit 118 of FIG. 1 are also shown in FIG. 4. Other elements of the processor-based device 100 are omitted from FIG. 4 for the sake of clarity.

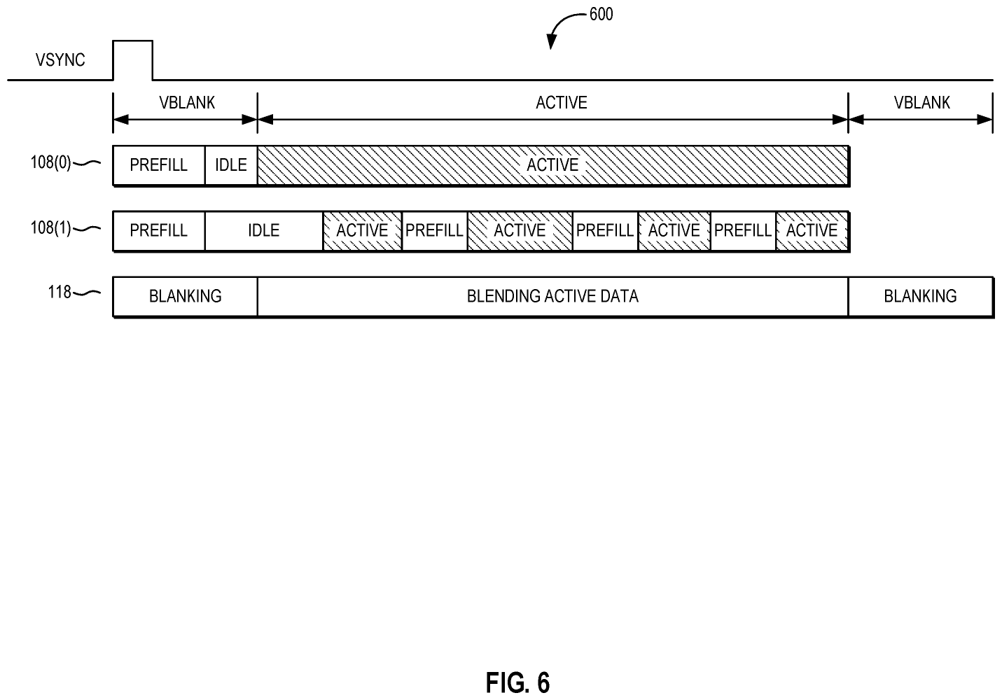

The memory access pipeline circuit 108(1) of FIG. 4 is configured to fetch and preblend a plurality of non-overlapping layer images, such as the non-overlapping layer images 202(0)-202(3) of FIG. 2, using the fetch circuit 110(1). The memory access pipeline circuit 108(1) then uses the preblending circuit 122(1) to blend the non-overlapping layer images 202(0)-202(3) into an intermediate preblend image data stream 400 that is provided to the layer mixer circuit 118. The memory access pipeline circuit 108(0) of FIG. 4 is configured to fetch a background layer image, such as the background layer image 200 of FIG. 2, and to provide a background layer image data stream 402 to the layer mixer circuit 118. The layer mixer circuit 118 then blends the background layer image data stream 402 and the intermediate preblend image data stream 400 into a display data stream 404, which is then sent to the display device 106 for display. An example of an intermediate preblend image that may be generated and sent as the intermediate preblend image data stream 400 is shown and discussed in greater detail below with respect to FIG. 6.

To generate the intermediate preblend image data stream 400, the memory access pipeline circuit 108(1) in some aspects may first obtain image configuration data (captioned as “IMG CONFIG” in FIG. 4) 406 for each of the non-overlapping layer images 202(0)-202(3). The image configuration data 406 may comprise, as non-limiting examples, a source image size, an output image size, a set of source image position coordinates, a set of output image position coordinates, a source address, a stride value, an image format, and/or an unpack pattern value for the corresponding non-overlapping layer images 202(0)-202(3). The image configuration data 406 for each of the non-overlapping layer images 202(0)-202(3) may be provided by a software process (not shown) such as a driver process. In some aspects, the image configuration data 406 may be placed into a plurality of image configuration registers (captioned as “IMG CONFIG REG” in FIG. 4) 408(0)-408(C), which then may be used to push the image configuration data 406 into one of a plurality of image configuration queue entries (captioned as “ENTRY” in FIG. 4) 410(0)-410(Q) of an image configuration queue (captioned as “IMG CONFIG QUEUE” in FIG. 4) 412(0). For instance, the image configuration data 406 for each of the non-overlapping layer images 202(0)-202(3) may be pushed into the image configuration queue 412(0) in an order reflecting the vertical location of each of the non-overlapping layer images 202(0)-202(3) (e.g., in ascending order of Y coordinates). The memory access pipeline circuit 108(1) may then obtain the image configuration data 406 for each non-overlapping layer image 202(0)-202(3) from a top entry (e.g., the image configuration queue entry 410(0) of FIG. 4) in the image configuration queue 412(0) by “popping” the image configuration queue entry 410(0) from the image configuration queue 412(0).

Some aspects may provide that, as the memory access pipeline circuit 108(1) receives the image configuration data 406 for each non-overlapping layer image 202(0)-202(3), the memory access pipeline circuit 108(1) may calculate a set of position coordinates (captioned as “POSITION” in FIG. 4) 414 and a size 416 of the intermediate preblend image to be generated, based on the image configuration data 406 received for the plurality of non-overlapping layer images 202(0)-202(3). For example, the relative sizes and locations of the non-overlapping layer images 202(0)-202(3) can be used by the memory access pipeline circuit 108(1) to determine a size and position of the intermediate preblend image that encompasses all of the non-overlapping layer images 202(0)-202(3). The memory access pipeline circuit 108(1) may then transmit the set of position coordinates 414 and the size 416 of the intermediate preblend image to the layer mixer circuit 118 for use in blending the intermediate preblend image data stream 400 and the background layer image data stream 402.

In some aspects, the memory access pipeline circuit 108(1) may provide two (2) image configuration queues 412(0) and 412(1). In such aspects, the memory access pipeline circuit 108(1) is configured to obtain image configuration data 406 from, e.g., the image configuration queue 412(0) while receiving, in parallel, image configuration data 406 for a next set of non-overlapping layer images (not shown) into a plurality of image configuration queue entries (captioned as “ENTRY” in FIG. 4) 418(0)-418(Q) of the image configuration queue 412(1). The selection of the image configuration queue 412(0) or the image configuration queue 412(1) as the “active” queue from which image configuration data 406 is being read may be accomplished using, e.g., one of the image configuration registers 408(0)-408(C).

Exemplary image configuration registers 408(0)-408(C) according to some aspects may include the registers described below in Table 1:

TABLE 1

| Configuration Register | Description |
|---|---|
| Multi Layer configuration enable | Used to enable Multi Layer |
| | configuration mode |
| Multi Layer push | Push all configuration data into |
| | configuration queue |
| Multi layer config set swap | Used to swap the active image |
| | configuration queue |

After obtaining the image configuration data 406 for a non-overlapping layer image such as the non-overlapping layer image 202(0) from the image configuration queue 412(0), the memory access pipeline circuit 108(1) then uses the preblending circuit 122(1) to output each pixel of the non-overlapping layer image 202(0) as part of the intermediate preblend image to the intermediate preblend image data stream 400 based on the image configuration data 406 for the non-overlapping layer image 202(0). In some aspects, the operations for outputting each pixel of the non-overlapping layer image 202(0) to the intermediate preblend image data stream 400 involves outputting a blend bypass pixel (e.g., a pixel having a pre-specified color value) for each pixel of the intermediate preblend image that does not correspond to a pixel of the non-overlapping layer image 202(0), wherein the blend bypass pixel information contains coordinates (e.g., X and Y positions) of the intermediate preblend image.

The preblending circuit 122(1) uses the image configuration data to determine destination coordinates for the non-overlapping layer image 202(0) in the intermediate preblend image and tracks output pixel positions. Upon completing processing for the non-overlapping layer image 202(0), the memory access pipeline circuit 108(1) then obtains the image configuration data 406 for the next non-overlapping layer image (e.g., the non-overlapping layer image 202(1)) from the image configuration queue 412(0), and begins processing the image data for the non-overlapping layer image 202(1).

The layer mixer circuit 118 subsequently blends the intermediate preblend image data stream 400 and the background layer image data stream 402 into the display data stream 404 by blending each pixel of the intermediate preblend image data stream 400 that corresponds to one of the non-overlapping layer images 202(0)-202(3) with a corresponding pixel of the background layer image 200. In some aspects, each of the non-overlapping layer images 202(0)-202(3) may be associated with different alpha mode data (not shown) and/or different alpha value data (not shown) that is used by the layer mixer circuit 118 when blending each pixel of the intermediate preblend image data stream 400 that corresponds to one of the non-overlapping layer images 202(0)-202(3) with a corresponding pixel of the background layer image 200. The alpha mode data and/or alpha value data in some aspects may be stored in software-configurable read and write registers provided for each of a plurality of blend stages, which are discussed in greater detail below. The layer mixer circuit 118 also outputs a corresponding pixel of the background layer image 200 to the display data stream 404 for each blend bypass pixel of the intermediate preblend image data stream 400.

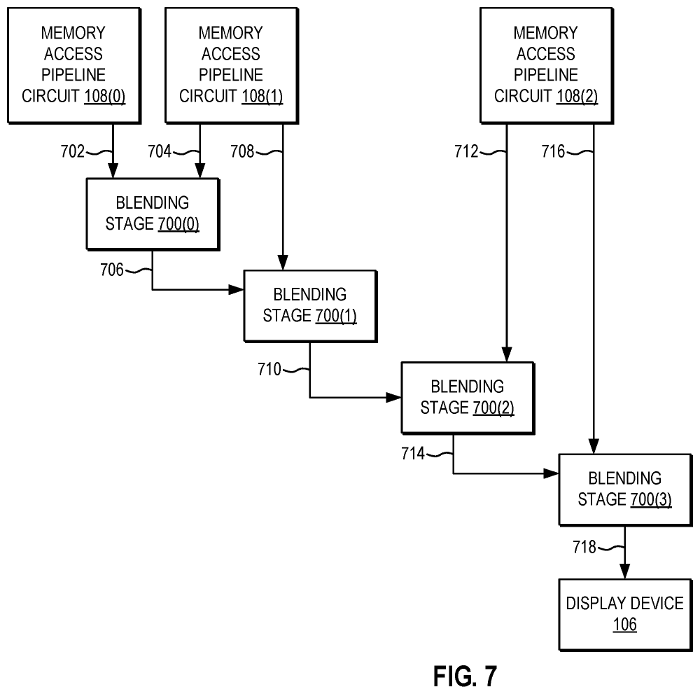

Some aspects of the layer mixer circuit 118 may provide that the non-overlapping layer images 202(0)-202(3) within the intermediate preblend image data stream 400 may each be processed within a separate blending stage of a plurality of blending stages, as discussed in greater detail below with respect to FIG. 7. For instance, in some such aspects, the background layer image data stream 402 and the intermediate preblend image data stream 400 may be blended by the layer mixer circuit 118 in a first blending stage. The resulting display data stream 404 may subsequently be used as a background layer image data stream to be combined with another intermediate preblend image data stream from another memory access pipeline circuit in a second blending stage, with the display data stream from the second blending stage being sent to the display device 106 for display. This functionality may enable, for example, the use of multiple memory access pipeline circuits that support the fetching of multiple non-overlapping layer images to generate the final display data stream.

To support functionality for providing blending stages, the layer mixer circuit 118 in some aspects provides a plurality of layer mixer configuration queues (captioned as “LM CONFIG QUEUE” in FIG. 4) 420(0)-420(L), each comprising a plurality of layer mixer configuration queue entries (captioned as “ENTRY” in FIG. 4) 422(0)-422(M), 424(0)-424(M). Some aspects may provide that the number of layer mixer configuration queues 420(0)-420(L) is the same as the number of memory access pipeline circuits 108(0)-108(M) of FIG. 1, such that each memory access pipeline circuit 108(0)-108(M) that supports fetching multiple non-overlapping layer images is associated with one of the layer mixer configuration queues 420(0)-420(L). In some aspects, there may be fewer layer mixer configuration queues 420(0)-420(L) than memory access pipeline circuits 108(0)-108(M). In such aspects, each layer mixer configuration queue 420(0)-420(L) is associated with a corresponding tag 426(0)-426(L), which may be assigned to one of the memory access pipeline circuits 108(0)-108(M) to indicate that the configuration data stored therein is to be accessed when processing data from the memory access pipeline circuits 108(0)-108(M). In this manner, the layer mixer configuration queues 420(0)-420(L) may be reassigned to different ones of the memory access pipeline circuits 108(0)-108(M), which in turn enables the memory access pipeline circuits 108(0)-108(M) to send image data to different blending stages.

The layer mixer configuration queues 420(0)-420(L) may be populated, e.g., by a software process such as a driver process, using layer mixer configuration registers (captioned as “LM CFG REG” in FIG. 4) 428(0)-428(F). Exemplary layer mixer configuration registers 428(0)-428(F) according to some aspects may include the registers described below in Table 2:

TABLE 2

| Configuration Register | Description |
|---|---|
| Multi Layer configuration | Used to enable Multi Layer configuration |
| enable | mode |
| Multi Layer push | Push blending stage indication into layer |
| | mixer configuration queue, and assign tag |
| | of layer mixer configuration queue to |
| | memory access pipeline circuit with |
| | source identifier |
| Source identifier | Identifier of memory access pipeline |
| | circuit that supports fetching multiple |
| | non-overlapping layers |
| Blending stage indication | Destination blending stage |

When the layer mixer circuit 118 receives an intermediate preblend data stream from a memory access pipeline circuit such as the memory access pipeline circuit 108(1), or receives an end-of-line (EOL) indication upon detection of bypass_Y, the layer mixer circuit 118 obtains a memory access pipeline identifier (not shown) and a blending stage indication (not shown) from the layer mixer configuration queue 420(0)-420(L) identified by the tag associated with the memory access pipeline circuit 108(1) (e.g., by popping the top layer mixer configuration queue entry 422(0) from the layer mixer configuration queue 420(0)). The layer mixer circuit 118 then blends the intermediate preblend image data stream (e.g., the intermediate preblend image data stream 400) and the background layer image data stream (e.g., the background layer image data stream 402) in the appropriate blending stage based on the blending stage indication. An example of the use of blending stages in this manner is discussed in greater detail below with respect to FIG. 7.

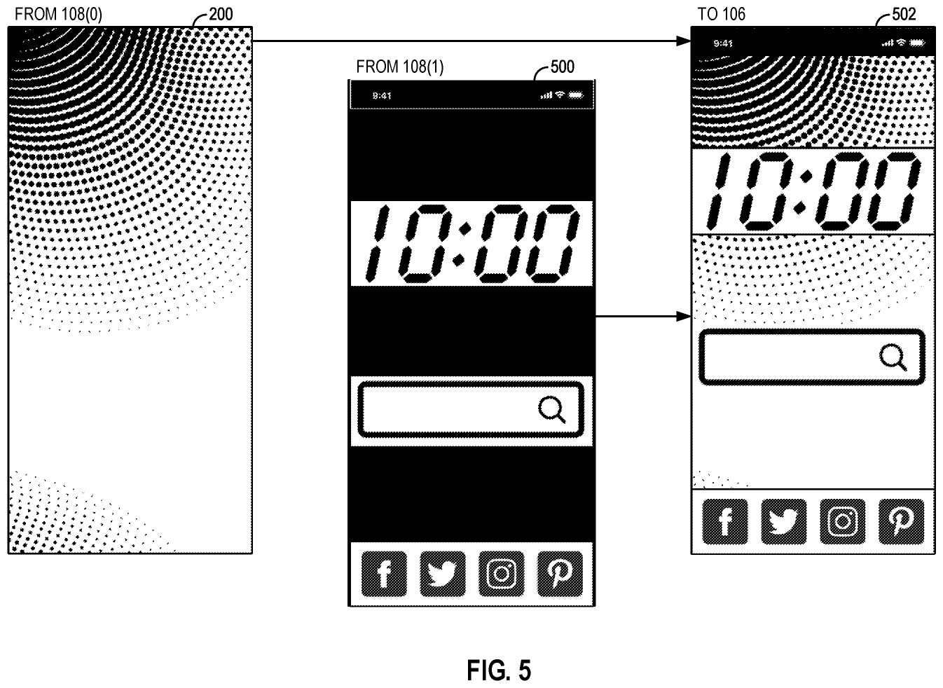

Exemplary results of the operations described above with respect to FIG. 4 are shown in FIG. 5. In FIG. 5, the background layer image 200 that is fetched and processed by the memory access pipeline circuit 108(0) of FIGS. 1 and 4 is shown. As seen in FIG. 5, the non-overlapping layer images 202(0)-202(3) have been combined into an intermediate preblend image 500, in which regions of black pixels are used to represent bypass pixels that do not correspond to pixels of any of the non-overlapping layer images 202(0)-202(3). The layer mixer circuit 118 then blends the background layer image 200, received as the background layer image data stream 402 of FIG. 4, and the intermediate preblend image 500, received as the intermediate preblend image data stream 400 of FIG. 4 from the memory access pipeline circuit 108(1) of FIGS. 1 and 4, into a final blended image 502 that is sent to the display device 106 of FIGS. 1 and 4 as the display data stream 404 of FIG. 4. In the example of FIGS. 4 and 5, generation of the final blended image 502 requires only two (2) memory access pipeline circuits, instead of the five (5) memory access pipeline circuits needed in the example of FIG. 2.

FIG. 6 shows a processing timeline 600 that illustrates the activity of the memory access pipeline circuits 108(0) and 108(1) and the layer mixer circuit 118 of FIG. 4, operating as described above with respect to FIG. 4, during one display screen refresh cycle. In FIG. 6, the caption “VSYNC” indicates the beginning of vertical synchronization, while the captions “VBLANK” and “BLANKING” indicate periods of time during which image data is not being transmitted to the display device 106 by the layer mixer circuit 118. The caption “PREFILL” in FIG. 6 indicates periods of time during which each of the memory access pipeline circuits 108(0) and 108(1) is fetching and filling corresponding buffers 112(0) and 112(1), while the caption “IDLE” indicates periods of time during which each of the memory access pipeline circuits 108(0) and 108(1) is waiting to transmit image data streams to the layer mixer circuit 118. Finally, in FIG. 6, the caption “ACTIVE” indicates periods of time during which each of the memory access pipeline circuits 108(0) and 108(1) is actively processing and transmitting an image data stream to the layer mixer circuit 118, and the caption “BLENDING ACTIVE DATA” indicates the period of time during which the layer mixer circuit 118 is blending image data streams and transmitting a display data stream to the display device 106.

As seen in FIG. 6, the memory access pipeline circuit 108(0), which is processing and transmitting the background layer image data stream for the background layer image 200, is active during the entire time that the layer mixer circuit 118 is blending image data streams and transmitting the display data stream to the display device 106. In addition, the memory access pipeline circuit 108(0), which fetches and preblends the non-overlapping layer images 202(0)-202(3), is also utilized for a large portion of the total time required to generate the final display data stream.

As discussed above with respect to FIG. 4, the layer mixer circuit 118 may employ multiple blending stages to blend images received from multiple memory access pipeline circuits. To illustrate such use of multiple blending stages within the layer mixer circuit 118, FIG. 7 is provided. As seen in FIG. 7, three (3) memory access pipeline circuits 108(0)-108(2) are providing image data that will be processed using four (4) blending stages 700(0)-700(3). In this example, the memory access pipeline circuit 108(0) provides a background layer image data stream 702, while the memory access pipeline circuit 108(1) provides a first intermediate preblend data stream 704. The layer mixer circuit 118 processes the background layer image data stream 702 and the first intermediate preblend data stream 704 into a display data stream 706, which is then used as a background layer image data stream 706 into the next blending stage 700(1). For the blending stage 700(1), the memory access pipeline circuit 108(1) provides a second intermediate preblend data stream 708, which the layer mixer circuit 118 blends with the background layer image data stream 706 into a display data stream 710. The display data stream 710 is then used as a background layer image data stream 710 into the blending stage 700(2).

The memory access pipeline circuit 108(2) next provides a first intermediate preblend data stream 712 to the blending stage 700(2), which the layer mixer circuit 118 blends with the background layer image data stream 710 to generate a display data stream 714. The display data stream 714 is then provided to the final blending stage 700(3) as a background layer image data stream 714. The memory access pipeline circuit 108(2) provides a second intermediate preblend data stream 716 to the final blending stage 700(3), which is blended with the background layer image data stream 714 into a display data stream 718. The display data stream 718 is then output to the display device 106 for display.

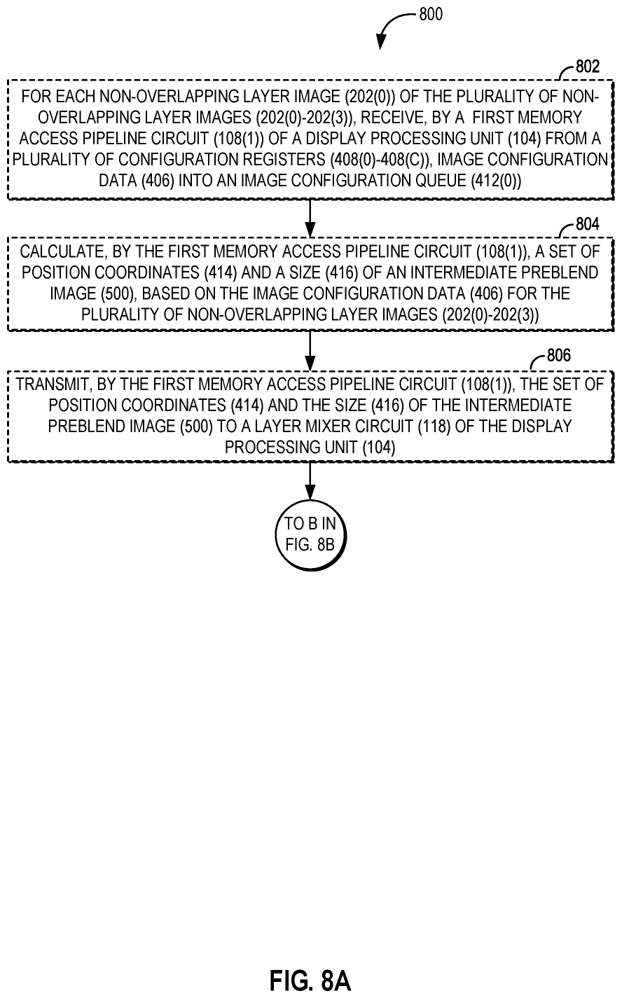

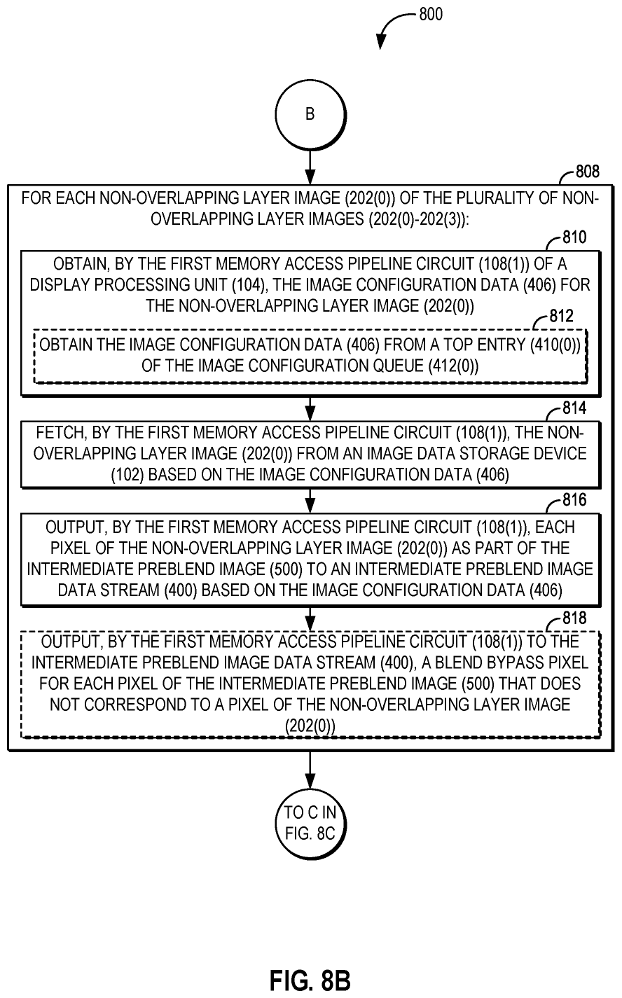

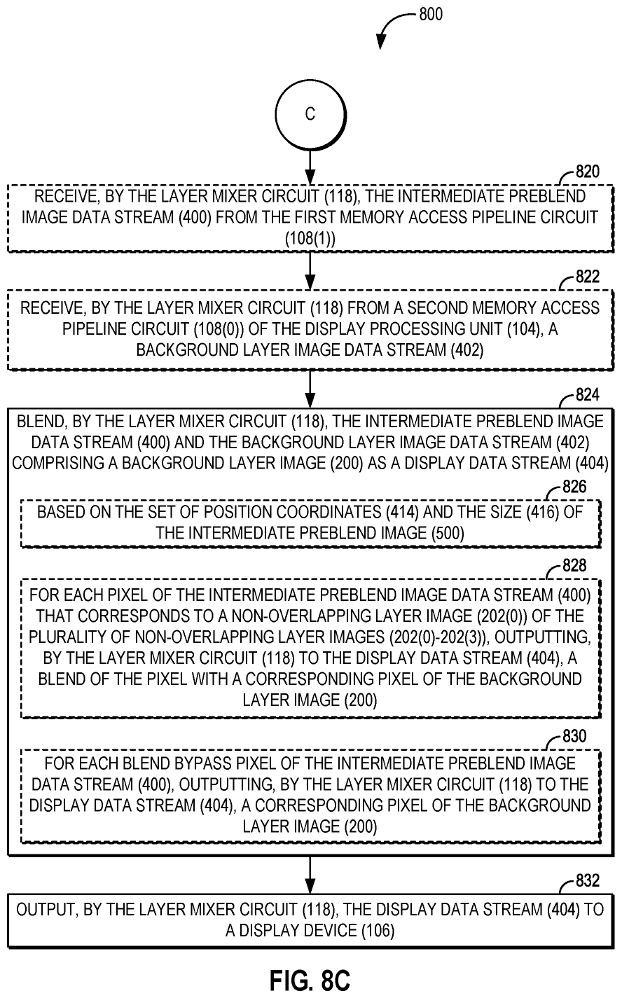

To illustrate exemplary operations by the display processing unit 104 of FIGS. 1 and 4 for efficiently processing multiple non-overlapping layer images, FIGS. 8A-8C provides a flowchart illustrating exemplary operations 800. For the sake of clarity, elements of FIGS. 1, 2, and 4-6 are referenced in describing FIGS. 8A-8C. The exemplary operations 800 in some aspects begin in FIG. 8A with a first memory access pipeline circuit, such as the memory access pipeline circuit 108(1) of FIGS. 1 and 4, of a display processing unit, such as the display processing unit 104 of FIGS. 1 and 4, receiving, for each non-overlapping layer image of a plurality of non-overlapping layer images (e.g., the non-overlapping layer image 202(0) of the plurality of non-overlapping layer images 202(0)-202(3) of FIG. 2) from a plurality of image configuration registers (e.g., the image configuration registers 408(0)-408(C) of FIG. 4), image configuration data (e.g., the image configuration data 406 of FIG. 4) into an image configuration queue, such as the image configuration queue 412(0) of FIG. 4 (block 802). The memory access pipeline circuit 108(1) in some aspects may calculate a set of position coordinates (e.g., the set of position coordinates 414 of FIG. 4) and a size (e.g., the size 416 of FIG. 4) of an intermediate preblend image (such as the intermediate preblend image 500 of FIG. 5), based on the image configuration data 406 for the plurality of non-overlapping layer images 202(0)-202(3) (block 804). The memory access pipeline circuit 108(1) in such aspects may then transmit the set of position coordinates 414 and the size 416 of the intermediate preblend image 500 to a layer mixer circuit (e.g., the layer mixer circuit 118 of FIGS. 1 and 4) of the display processing unit 104 (block 806). The exemplary operations 800 then continue at block 808 of FIG. 8B.

Referring now to FIG. 8B, a series of operations is performed for each non-overlapping layer image 202(0) of the plurality of non-overlapping layer images 202(0)-202(3) (block 808). The memory access pipeline circuit 108(1) obtains the image configuration data 406 for the non-overlapping layer image 202(0) (block 810). In some aspects, the operations of block 810 for obtaining the image configuration data 406 may comprise the memory access pipeline circuit 108(1) obtaining the image configuration data 406 from a top entry (e.g., the image configuration queue entry 410(0) of FIG. 4) of the image configuration queue 412(0) (block 812). The memory access pipeline circuit 108(1) then fetches the non-overlapping layer image 202(0) from an image data storage device (e.g., the image data storage device 102 of FIGS. 1 and 4) based on the image configuration data 406 (block 814).

The memory access pipeline circuit 108(1) then outputs each pixel of the non-overlapping layer image 202(0) as part of the intermediate preblend image 500 to an intermediate preblend image data stream (e.g., the intermediate preblend image data stream 400 of FIG. 4) based on the image configuration data 406 (block 816). According to some aspects, the operations of block 816 for outputting each pixel of the non-overlapping layer image 202(0) as part of the intermediate preblend image 500 to the intermediate preblend image data stream 400 may comprise outputting a blend bypass pixel for each pixel of the intermediate preblend image 500 that does not correspond to a pixel of the non-overlapping layer image 202(0) (block 818). The exemplary operations 800 then continue at block 820 of FIG. 8C.

Turning now to FIG. 8C, some aspects may provide that the layer mixer circuit 118 receives the intermediate preblend image data stream 400 from the memory access pipeline circuit 108(1) (block 820). The layer mixer circuit 118 may also receive, from a second memory access pipeline circuit of the display processing unit 104 (such as the memory access pipeline circuit 108(0) of FIGS. 1 and 4), a background layer image data stream (e.g., the background layer image data stream 402 of FIG. 4) (block 822). The layer mixer circuit 118 then blends the intermediate preblend image data stream 400 and the background layer image data stream 402 comprising a background layer image (e.g., the background layer image 200 of FIGS. 2 and 5) as a display data stream (e.g., the display data stream 404 of FIG. 4) (block 824). In some aspects, the operations of block 824 for blending the intermediate preblend image data stream 400 and the background layer image data stream 402 may be based on the set of position coordinates 414 and the size 416 of the intermediate preblend image 500 (block 826). Some aspects may provide that the operations of block 824 for blending the intermediate preblend image data stream 400 and the background layer image data stream 402 may comprise the layer mixer circuit 118 outputting, for each pixel of the intermediate preblend image data stream 400 that corresponds to a non-overlapping layer image 202(0) of the plurality of non-overlapping layer images 202(0)-202(3), a blend of the pixel with a corresponding pixel of the background layer image 200 to the display data stream 404 (block 828). According to some aspects, the operations of block 824 for blending the intermediate preblend image data stream 400 and the background layer image data stream 402 may comprise the layer mixer circuit 118, outputting, for each blend bypass pixel of the intermediate preblend image data stream 400, a corresponding pixel of the background layer image 200 to the display data stream 404 (block 830). The layer mixer circuit 118 then outputs the display data stream 404 to a display device 106 (block 832).

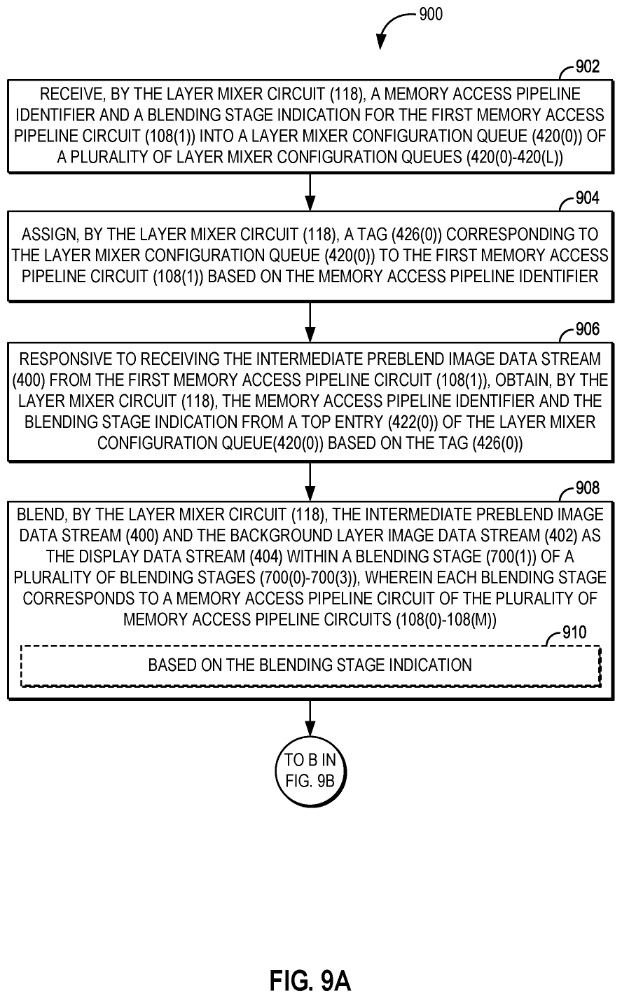

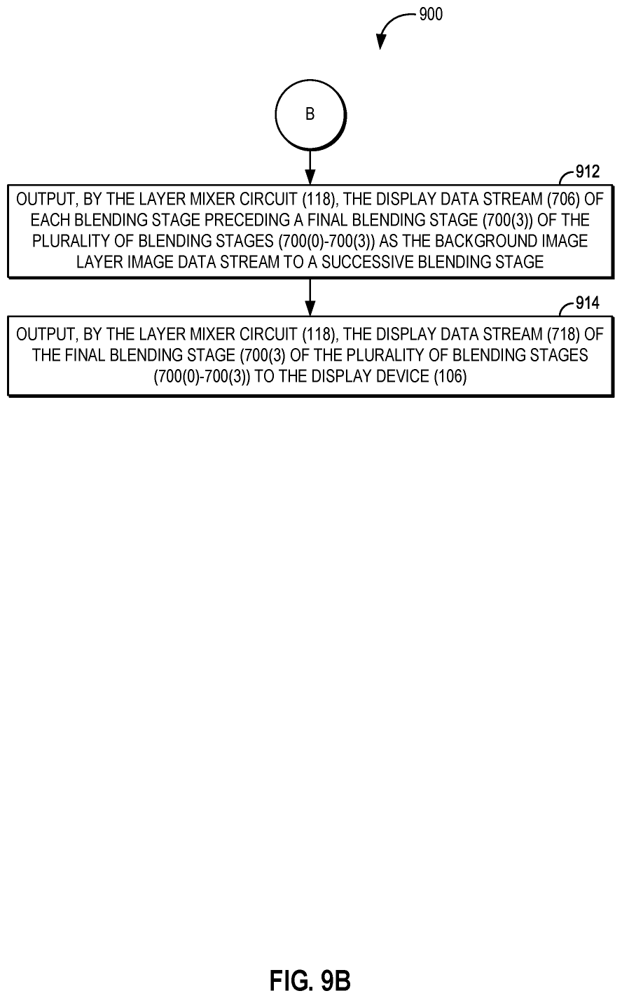

FIGS. 9A and 9B provide a flowchart illustrating exemplary operations 900 performed by the layer mixer circuit of FIGS. 1 and 4 for blending images from multiple memory access pipeline circuits using blending stages, according to some aspects. Elements of FIGS. 1, 4, and 7 are referenced in describing FIGS. 9A and 9B for the sake of clarity. In FIG. 9A, the exemplary operations 900 begin with the layer mixer circuit 118 receiving a memory access pipeline identifier and a blending stage indication for the memory access pipeline circuit 108(1) into a layer mixer configuration queue of a plurality of layer mixer configuration queues (e.g., the layer mixer configuration queue 420(0) of the plurality of layer mixer configuration queues 420(0)-420(L) of FIG. 4) (block 902). The layer mixer circuit 118 assigns a tag (e.g., the tag 426(0) of FIG. 4) corresponding to the layer mixer configuration queue 420(0) to the memory access pipeline circuit 108(1) based on the memory access pipeline identifier (block 904).

Subsequently, when the layer mixer circuit 118 receives the intermediate preblend image data stream 400 from the memory access pipeline circuit 108(1), the layer mixer circuit 118 obtains the memory access pipeline identifier and the blending stage indication from a top entry (e.g., the layer mixer configuration queue entry 422(0) of FIG. 4) of the layer mixer configuration queue 420(0) based on the tag 426(0) (block 906). The layer mixer circuit 118 then blends the intermediate preblend image data stream 400 and the background layer image data stream 402 as the display data stream 404 within a blending stage of a plurality of blending stages (e.g., the blending stage 700(1) of the plurality of blending stages 700(0)-700(3) of FIG. 7), wherein each blending stage corresponds to a memory access pipeline circuit of the plurality of memory access pipeline circuits 108(0)-108(M) (block 908). In some aspects, the operations of block 908 for blending the intermediate preblend image data stream 400 and the background layer image data stream 402 as the display data stream 404 within the blending stage 700(1) is based on the blending stage indication (block 910). It is to be understood that the operations of block 908 and 910 in some aspects may correspond to the operations of block 824 of FIG. 8C. The exemplary operations 900 then continue at block 912 of FIG. 9B.

Referring now to FIG. 9B, the exemplary operations 900 continue with the layer mixer circuit 118 outputting the display data stream (e.g., the display data stream 706 of FIG. 7) of each blending stage preceding a final blending stage (e.g., the blending stage 700(3) of FIG. 7) of the plurality of blending stages 700(0)-700(3) as the background layer image data stream (e.g., the background layer image data stream 702 of FIG. 7) to a successive blending stage (e.g., the blending stage 700(1) of FIG. 7) (block 912). The layer mixer circuit 118 then outputs the display data stream of the final blending stage 700(3) (e.g., the display data stream 718 of FIG. 7) of the plurality of blending stages 700(0)-700(3) to the display device 106 (block 914). It is to be understood that the operations of block 912 and 914 in some aspects may correspond to the operations of block 832 of FIG. 8C.

Efficiently processing multiple non-overlapping layer images according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

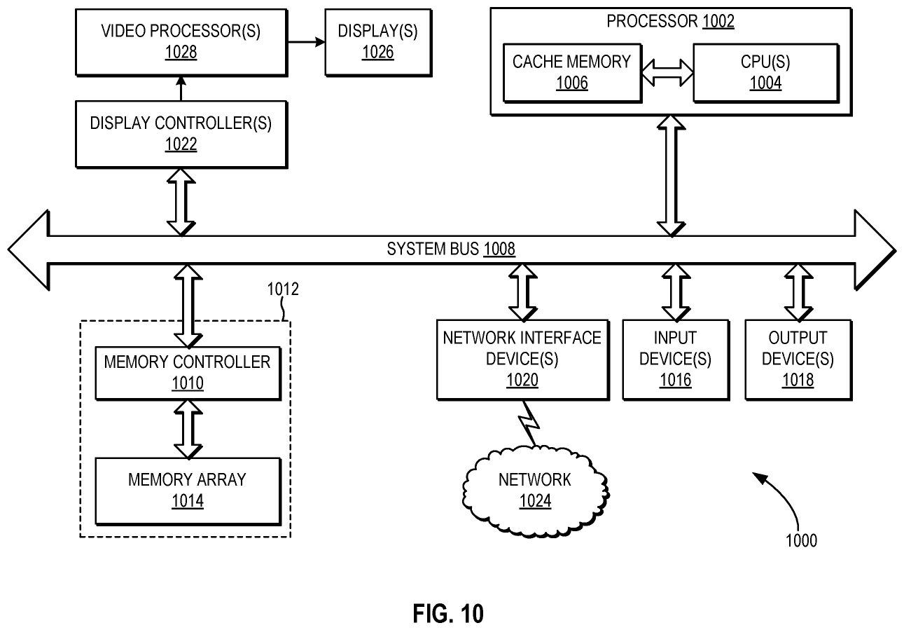

In this regard, FIG. 10 illustrates an example of a processor-based device 1000 that may comprise the display processing unit 104 illustrated in FIG. 1. In this example, the processor-based device 1000 includes a processor 1002 that includes one or more central processing units (captioned as “CPUs” in FIG. 10) 1004, which may also be referred to as CPU cores or processor cores. The processor 1002 may have cache memory 1006 coupled to the processor 1002 for rapid access to temporarily stored data. The processor 1002 is coupled to a system bus 1008 and can intercouple master and slave devices included in the processor-based device 1000. As is well known, the processor 1002 communicates with these other devices by exchanging address, control, and data information over the system bus 1008. For example, the processor 1002 can communicate bus transaction requests to a memory controller 1010, as an example of a slave device. Although not illustrated in FIG. 10, multiple system buses 1008 could be provided, wherein each system bus 1008 constitutes a different fabric.

Other master and slave devices can be connected to the system bus 1008. As illustrated in FIG. 10, these devices can include a memory system 1012 that includes the memory controller 1010 and a memory array(s) 1014, one or more input devices 1016, one or more output devices 1018, one or more network interface devices 1020, and one or more display controllers 1022, as examples. The input device(s) 1016 can include any type of input device, including but not limited to input keys, switches, voice processors, etc. The output device(s) 1018 can include any type of output device, including, but not limited to, audio, video, other visual indicators, etc. The network interface device(s) 1020 can be any device configured to allow exchange of data to and from a network 1024. The network 1024 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 1020 can be configured to support any type of communications protocol desired.

The processor 1002 may also be configured to access the display controller(s) 1022 over the system bus 1008 to control information sent to one or more displays 1026. The display controller(s) 1022 sends information to the display(s) 1026 to be displayed via one or more video processors 1028, which process the information to be displayed into a format suitable for the display(s) 1026. The display(s) 1026 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A display processing unit, comprising:
   a plurality of memory access pipeline circuits;
   a layer mixer circuit;
   a first memory access pipeline circuit of the plurality of memory access pipeline circuits configured to, for each non-overlapping layer image of a plurality of non-overlapping layer images:
      obtain image configuration data for the non-overlapping layer image;
      fetch the non-overlapping layer image from an image data storage device based on the image configuration data; and
      output each pixel of the non-overlapping layer image as part of an intermediate preblend image to an intermediate preblend image data stream based on the image configuration data; and
   the layer mixer circuit configured to:
      blend the intermediate preblend image data stream and a background layer image data stream comprising a background layer image as a display data stream; and
      output the display data stream to a display device.
2. The display processing unit of clause 1, wherein the layer mixer circuit is further configured to:
   receive the intermediate preblend image data stream from the first memory access pipeline circuit; and
   receive the background layer image data stream from a second memory access pipeline circuit of the plurality of memory access pipeline circuits.
3. The display processing unit of any one of clauses 1-2, wherein the image configuration data for each non-overlapping layer image of the plurality of the non-overlapping layer images comprises one or more of a source image size, an output image size, a set of source image position coordinates, a set of output image position coordinates, a source address, a stride value, an image format, and an unpack pattern value.
4. The display processing unit of any one of clauses 1-3, wherein:
   the first memory access pipeline circuit further comprises an image configuration queue;
   the first memory access pipeline circuit is further configured to, for each non-overlapping layer image of the plurality of non-overlapping layer images, receive, from a plurality of image configuration registers, the image configuration data into the image configuration queue; and the first memory access pipeline circuit is configured to, for each non-overlapping layer image of the plurality of non-overlapping layer images, obtain the image configuration data from a top entry of the image configuration queue.
5. The display processing unit of clause 4, wherein:
   the first memory access pipeline circuit is further configured to:
      calculate a set of position coordinates and a size of the intermediate preblend image, based on the image configuration data for the plurality of non-overlapping layer images; and
      transmit the set of position coordinates and the size of the intermediate preblend image to the layer mixer circuit; and
   the layer mixer circuit configured to blend the intermediate preblend image data stream and the background layer image data stream as the display data stream based on the set of position coordinates and the size of the intermediate preblend image.
6. The display processing unit of any one of clauses 4-5, wherein:
   the first memory access pipeline circuit comprises a first selectable image configuration queue and a second selectable image configuration queue;
   the first memory access pipeline circuit is further configured to, for each non-overlapping layer image of the plurality of non-overlapping layer images, receive, from a plurality of image configuration registers, the image configuration data into the first selectable image configuration queue;
   the first memory access pipeline circuit is configured to, for each non-overlapping layer image of the plurality of non-overlapping layer images, obtain the image configuration data from a top entry of the first selectable image configuration queue; and
   the first memory access pipeline circuit is further configured to, in parallel with obtaining the image configuration data from the top entry of the first selectable image configuration queue, for each non-overlapping layer image of a next plurality of non-overlapping layer images, receive, from the plurality of image configuration registers, next image configuration data into the second selectable image configuration queue.
7. The display processing unit of any one of clauses 1-6, wherein the layer mixer circuit is configured to blend the intermediate preblend image data stream and the background layer image data stream as the display data stream by being configured to, for each pixel of the intermediate preblend image data stream that corresponds to a non-overlapping layer image of the plurality of non-overlapping layer images, output, to the display data stream, a blend of the pixel with a corresponding pixel of the background layer image.
8. The display processing unit of clause 7, wherein:
   the first memory access pipeline circuit is further configured to, for each non-overlapping layer image of the plurality of non-overlapping layer images, output, to the intermediate preblend image data stream, a blend bypass pixel for each pixel of the intermediate preblend image that does not correspond to a pixel of the non-overlapping layer image; and
   the layer mixer circuit is configured to blend the intermediate preblend image data stream and the background layer image data stream as the display data stream by being configured to, for each blend bypass pixel of the intermediate preblend image data stream, output, to the display data stream, a corresponding pixel of the background layer image.
9. The display processing unit of clause 8, wherein the blend bypass pixel comprises a pixel having a pre-specified color value.
10. The display processing unit of any one of clauses 2-9, wherein:
   the layer mixer circuit is configured to blend the intermediate preblend image data stream and the background layer image data stream as the display data stream by being configured to:
      blend the intermediate preblend image data stream and the background layer image data stream as the display data stream within a blending stage of a plurality of blending stages, wherein each blending stage corresponds to a memory access pipeline circuit of the plurality of memory access pipeline circuits; and
      output the display data stream of each blending stage preceding a final blending stage of the plurality of blending stages as the background layer image data stream to a successive blending stage; and
   the layer mixer circuit is configured to output the display data stream to the display device by being configured to output the display data stream of the final blending stage of the plurality of blending stages to the display device.
11. The display processing unit of clause 10, wherein:
   the layer mixer circuit further comprises a plurality of layer mixer configuration queues;
   the layer mixer circuit is further configured to:
      receive a memory access pipeline identifier and a blending stage indication for the first memory access pipeline circuit into a layer mixer configuration queue of the plurality of layer mixer configuration queues;
      assign a tag corresponding to the layer mixer configuration queue to the first memory access pipeline circuit based on the memory access pipeline identifier; and
      responsive to receiving the intermediate preblend image data stream from the first memory access pipeline circuit, obtain the memory access pipeline identifier and the blending stage indication from a top entry of the layer mixer configuration queue based on the tag; and
   the layer mixer circuit is configured to blend the intermediate preblend image data stream and the background layer image data stream as the display data stream within the blending stage of the plurality of blending stages based on the blending stage indication.
12. The display processing unit of any one of clauses 1-11, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
13. A display processing unit, comprising:
   means for, for each non-overlapping layer image of a plurality of non-overlapping layer images:
      obtaining image configuration data for the non-overlapping layer image;
      fetching the non-overlapping layer image from an image data storage device based on the image configuration data; and
      outputting each pixel of the non-overlapping layer image as part of an intermediate preblend image to an intermediate preblend image data stream based on the image configuration data;
   means for blending the intermediate preblend image data stream and a background layer image data stream comprising a background layer image as a display data stream; and
   means for outputting the display data stream to a display device.
14. A method for efficiently processing multiple non-overlapping layer images, the method comprising:
   for each non-overlapping layer image of a plurality of non-overlapping layer images:
      obtaining, by a first memory access pipeline circuit of a plurality of memory access pipeline circuits of a display processing unit, image configuration data for the non-overlapping layer image;
      fetching, by the first memory access pipeline circuit, the non-overlapping layer image from an image data storage device based on the image configuration data; and
      outputting, by the first memory access pipeline circuit, each pixel of the non-overlapping layer image as part of an intermediate preblend image to an intermediate preblend image data stream based on the image configuration data;
   blending, by a layer mixer circuit of the display processing unit, the intermediate preblend image data stream and a background layer image data stream as a display data stream; and
   outputting, by the layer mixer circuit, the display data stream to a display device.
15. The method of clause 14, further comprising:
   receiving, by the layer mixer circuit, the intermediate preblend image data stream from the first memory access pipeline circuit; and
   receiving, by the layer mixer circuit, the background layer image data stream comprising a background layer image from a second memory access pipeline circuit of the plurality of memory access pipeline circuits.
16. The method of any one of clauses 14-15, wherein the image configuration data for each non-overlapping layer image of the plurality of the non-overlapping layer images comprises one or more of a source image size, an output image size, a set of source image position coordinates, a set of output image position coordinates, a source address, a stride value, an image format, and an unpack pattern value.
17. The method of any one of clauses 14-16, further comprising, for each non-overlapping layer image of the plurality of non-overlapping layer images, receiving, by the first memory access pipeline circuit from a plurality of image configuration registers, the image configuration data into an image configuration queue of the first memory access pipeline circuit;
   wherein, for each non-overlapping layer image of the plurality of non-overlapping layer images, obtaining the image configuration data for the non-overlapping layer image comprises obtaining the image configuration data from a top entry of the image configuration queue.
18. The method of clause 17, further comprising:
   calculating, by the first memory access pipeline circuit, a set of position coordinates and a size of the intermediate preblend image, based on the image configuration data for the plurality of non-overlapping layer images; and
   transmitting, by the first memory access pipeline circuit, the set of position coordinates and the size of the intermediate preblend image to the layer mixer circuit;
   wherein blending the intermediate preblend image data stream and the background layer image data stream as the display data stream is based on the set of position coordinates and the size of the intermediate preblend image.
19. The method of any one of clauses 17-18, further comprising, for each non-overlapping layer image of the plurality of non-overlapping layer images, receiving, by the first memory access pipeline circuit from a plurality of image configuration registers, the image configuration data into a first selectable image configuration queue;
   wherein:
      for each non-overlapping layer image of the plurality of non-overlapping layer images, obtaining the image configuration data comprises obtaining the image configuration data from a top entry of the first selectable image configuration queue; and
      the method further comprises, in parallel with obtaining the image configuration data from the top entry of the first selectable image configuration queue, for each non-overlapping layer image of a next plurality of non-overlapping layer images, receiving, by the first memory access pipeline circuit from the plurality of image configuration registers, next image configuration data into a second selectable image configuration queue.
20. The method of any one of clauses 15-19, wherein blending the intermediate preblend image data stream and the background layer image data stream as the display data stream comprises, for each pixel of the intermediate preblend image data stream that corresponds to a non-overlapping layer image of the plurality of non-overlapping layer images, outputting, by the layer mixer circuit to the display data stream, a blend of the pixel with a corresponding pixel of the background layer image.
21. The method of any one of clauses 15-20, further comprising, for each non-overlapping layer image of the plurality of non-overlapping layer images, outputting, by the first memory access pipeline circuit to the intermediate preblend image data stream, a blend bypass pixel for each pixel of the intermediate preblend image that does not correspond to a pixel of the non-overlapping layer image;
   wherein blending the intermediate preblend image data stream and the background layer image data stream as the display data stream comprises, for each blend bypass pixel of the intermediate preblend image data stream, outputting, by the layer mixer circuit to the display data stream, a corresponding pixel of the background layer image.
22. The method of clause 21, wherein the blend bypass pixel comprises a pixel having a pre-specified color value.
23. The method of any one of clauses 15-22, wherein:
   blending the intermediate preblend image data stream and the background layer image data stream as the display data stream comprises:
      blending, by the layer mixer circuit, the intermediate preblend image data stream and the background layer image data stream as the display data stream within a blending stage of a plurality of blending stages, wherein each blending stage corresponds to a memory access pipeline circuit of the plurality of memory access pipeline circuits; and
      outputting, by the layer mixer circuit, the display data stream of each blending stage preceding a final blending stage of the plurality of blending stages as the background layer image data stream to a successive blending stage; and
   outputting the display data stream to the display device comprises outputting, by the layer mixer circuit, the display data stream of the final blending stage of the plurality of blending stages to the display device.
24. The method of clause 23, further comprising:
   receiving, by the layer mixer circuit, a memory access pipeline identifier and a blending stage indication for the first memory access pipeline circuit into a layer mixer configuration queue of a plurality of layer mixer configuration queues;
   assigning, by the layer mixer circuit, a tag corresponding to the layer mixer configuration queue to the first memory access pipeline circuit based on the memory access pipeline identifier; and
   responsive to receiving the intermediate preblend image data stream from the first memory access pipeline circuit, obtaining, by the layer mixer circuit, the memory access pipeline identifier and the blending stage indication from a top entry of the layer mixer configuration queue based on the tag;
   wherein blending the intermediate preblend image data stream and the background layer image data stream as the display data stream within the blending stage of the plurality of blending stages is based on the blending stage indication.

What is claimed is:

1. A display processing unit, comprising:
a plurality of memory access pipeline circuits;
a layer mixer circuit;
a first memory access pipeline circuit of the plurality of memory access pipeline circuits configured to, for each non-overlapping layer image of a plurality of non-overlapping layer images:
obtain image configuration data for the non-overlapping layer image;
fetch the non-overlapping layer image from an image data storage device based on the image configuration data; and
output each pixel of the non-overlapping layer image as part of an intermediate preblend image to an intermediate preblend image data stream based on the image configuration data; and
the layer mixer circuit configured to:
blend the intermediate preblend image data stream and a background layer image data stream comprising a background layer image as a display data stream; and
output the display data stream to a display device.

2. The display processing unit of claim 1, wherein the layer mixer circuit is further configured to:
receive the intermediate preblend image data stream from the first memory access pipeline circuit; and
receive the background layer image data stream from a second memory access pipeline circuit of the plurality of memory access pipeline circuits.

3. The display processing unit of claim 1, wherein the image configuration data for each non-overlapping layer image of the plurality of the non-overlapping layer images comprises one or more of a source image size, an output image size, a set of source image position coordinates, a set of output image position coordinates, a source address, a stride value, an image format, and an unpack pattern value.

4. The display processing unit of claim 1, wherein:
the first memory access pipeline circuit further comprises an image configuration queue;
the first memory access pipeline circuit is further configured to, for each non-overlapping layer image of the plurality of non-overlapping layer images, receive, from a plurality of image configuration registers, the image configuration data into the image configuration queue; and
the first memory access pipeline circuit is configured to, for each non-overlapping layer image of the plurality of non-overlapping layer images, obtain the image configuration data from a top entry of the image configuration queue.

5. The display processing unit of claim 4, wherein:
the first memory access pipeline circuit is further configured to:
calculate a set of position coordinates and a size of the intermediate preblend image, based on the image configuration data for the plurality of non-overlapping layer images; and
transmit the set of position coordinates and the size of the intermediate preblend image to the layer mixer circuit; and
the layer mixer circuit configured to blend the intermediate preblend image data stream and the background layer image data stream as the display data stream based on the set of position coordinates and the size of the intermediate preblend image.

6. The display processing unit of claim 4, wherein:
the first memory access pipeline circuit comprises a first selectable image configuration queue and a second selectable image configuration queue;
the first memory access pipeline circuit is further configured to, for each non-overlapping layer image of the plurality of non-overlapping layer images, receive, from a plurality of image configuration registers, the image configuration data into the first selectable image configuration queue;
the first memory access pipeline circuit is configured to, for each non-overlapping layer image of the plurality of non-overlapping layer images, obtain the image configuration data from a top entry of the first selectable image configuration queue; and
the first memory access pipeline circuit is further configured to, in parallel with obtaining the image configuration data from the top entry of the first selectable image configuration queue, for each non-overlapping layer image of a next plurality of non-overlapping layer images, receive, from the plurality of image configuration registers, next image configuration data into the second selectable image configuration queue.

7. The display processing unit of claim 1, wherein the layer mixer circuit is configured to blend the intermediate preblend image data stream and the background layer image data stream as the display data stream by being configured to, for each pixel of the intermediate preblend image data stream that corresponds to a non-overlapping layer image of the plurality of non-overlapping layer images, output, to the display data stream, a blend of the pixel with a corresponding pixel of the background layer image.

8. The display processing unit of claim 7, wherein:
the first memory access pipeline circuit is further configured to, for each non-overlapping layer image of the plurality of non-overlapping layer images, output, to the intermediate preblend image data stream, a blend bypass pixel for each pixel of the intermediate preblend image that does not correspond to a pixel of the non-overlapping layer image; and
the layer mixer circuit is configured to blend the intermediate preblend image data stream and the background layer image data stream as the display data stream by being configured to, for each blend bypass pixel of the intermediate preblend image data stream, output, to the display data stream, a corresponding pixel of the background layer image.

9. The display processing unit of claim 8, wherein the blend bypass pixel comprises a pixel having a pre-specified color value.

10. The display processing unit of claim 2, wherein:
the layer mixer circuit is configured to blend the intermediate preblend image data stream and the background layer image data stream as the display data stream by being configured to:
blend the intermediate preblend image data stream and the background layer image data stream as the display data stream within a blending stage of a plurality of blending stages, wherein each blending stage corresponds to a memory access pipeline circuit of the plurality of memory access pipeline circuits; and
output the display data stream of each blending stage preceding a final blending stage of the plurality of blending stages as the background layer image data stream to a successive blending stage; and
the layer mixer circuit is configured to output the display data stream to the display device by being configured to output the display data stream of the final blending stage of the plurality of blending stages to the display device.

11. The display processing unit of claim 10, wherein:
the layer mixer circuit further comprises a plurality of layer mixer configuration queues;
the layer mixer circuit is further configured to:
receive a memory access pipeline identifier and a blending stage indication for the first memory access pipeline circuit into a layer mixer configuration queue of the plurality of layer mixer configuration queues;
assign a tag corresponding to the layer mixer configuration queue to the first memory access pipeline circuit based on the memory access pipeline identifier; and
responsive to receiving the intermediate preblend image data stream from the first memory access pipeline circuit, obtain the memory access pipeline identifier and the blending stage indication from a top entry of the layer mixer configuration queue based on the tag; and
the layer mixer circuit is configured to blend the intermediate preblend image data stream and the background layer image data stream as the display data stream within the blending stage of the plurality of blending stages based on the blending stage indication.

12. The display processing unit of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

13. A display processing unit, comprising:
means for, for each non-overlapping layer image of a plurality of non-overlapping layer images:
obtaining image configuration data for the non-overlapping layer image;
fetching the non-overlapping layer image from an image data storage device based on the image configuration data; and
outputting each pixel of the non-overlapping layer image as part of an intermediate preblend image to an intermediate preblend image data stream based on the image configuration data;
means for blending the intermediate preblend image data stream and a background layer image data stream comprising a background layer image as a display data stream; and
means for outputting the display data stream to a display device.

14. A method for efficiently processing multiple non-overlapping layer images, the method comprising:
for each non-overlapping layer image of a plurality of non-overlapping layer images:
obtaining, by a first memory access pipeline circuit of a plurality of memory access pipeline circuits of a display processing unit, image configuration data for the non-overlapping layer image;
fetching, by the first memory access pipeline circuit, the non-overlapping layer image from an image data storage device based on the image configuration data; and
outputting, by the first memory access pipeline circuit, each pixel of the non-overlapping layer image as part of an intermediate preblend image to an intermediate preblend image data stream based on the image configuration data;
blending, by a layer mixer circuit of the display processing unit, the intermediate preblend image data stream and a background layer image data stream as a display data stream; and
outputting, by the layer mixer circuit, the display data stream to a display device.

15. The method of claim 14, further comprising:
receiving, by the layer mixer circuit, the intermediate preblend image data stream from the first memory access pipeline circuit; and
receiving, by the layer mixer circuit, the background layer image data stream comprising a background layer image from a second memory access pipeline circuit of the plurality of memory access pipeline circuits.

16. The method of claim 14, wherein the image configuration data for each non-overlapping layer image of the plurality of the non-overlapping layer images comprises one or more of a source image size, an output image size, a set of source image position coordinates, a set of output image position coordinates, a source address, a stride value, an image format, and an unpack pattern value.

17. The method of claim 14, further comprising, for each non-overlapping layer image of the plurality of non-overlapping layer images, receiving, by the first memory access pipeline circuit from a plurality of image configuration registers, the image configuration data into an image configuration queue of the first memory access pipeline circuit;
wherein, for each non-overlapping layer image of the plurality of non-overlapping layer images, obtaining the image configuration data for the non-overlapping layer image comprises obtaining the image configuration data from a top entry of the image configuration queue.

18. The method of claim 17, further comprising:
calculating, by the first memory access pipeline circuit, a set of position coordinates and a size of the intermediate preblend image, based on the image configuration data for the plurality of non-overlapping layer images; and
transmitting, by the first memory access pipeline circuit, the set of position coordinates and the size of the intermediate preblend image to the layer mixer circuit;
wherein blending the intermediate preblend image data stream and the background layer image data stream as the display data stream is based on the set of position coordinates and the size of the intermediate preblend image.

19. The method of claim 17, further comprising, for each non-overlapping layer image of the plurality of non-overlapping layer images, receiving, by the first memory access pipeline circuit from a plurality of image configuration registers, the image configuration data into a first selectable image configuration queue;
wherein:
for each non-overlapping layer image of the plurality of non-overlapping layer images, obtaining the image configuration data comprises obtaining the image configuration data from a top entry of the first selectable image configuration queue; and
the method further comprises, in parallel with obtaining the image configuration data from the top entry of the first selectable image configuration queue, for each non-overlapping layer image of a next plurality of non-overlapping layer images, receiving, by the first memory access pipeline circuit from the plurality of image configuration registers, next image configuration data into a second selectable image configuration queue.

20. The method of claim 15, wherein blending the intermediate preblend image data stream and the background layer image data stream as the display data stream comprises, for each pixel of the intermediate preblend image data stream that corresponds to a non-overlapping layer image of the plurality of non-overlapping layer images, outputting, by the layer mixer circuit to the display data stream, a blend of the pixel with a corresponding pixel of the background layer image.

21. The method of claim 15, further comprising, for each non-overlapping layer image of the plurality of non-overlapping layer images, outputting, by the first memory access pipeline circuit to the intermediate preblend image data stream, a blend bypass pixel for each pixel of the intermediate preblend image that does not correspond to a pixel of the non-overlapping layer image;
wherein blending the intermediate preblend image data stream and the background layer image data stream as the display data stream comprises, for each blend bypass pixel of the intermediate preblend image data stream, outputting, by the layer mixer circuit to the display data stream, a corresponding pixel of the background layer image.

22. The method of claim 21, wherein the blend bypass pixel comprises a pixel having a pre-specified color value.

23. The method of claim 15, wherein:
blending the intermediate preblend image data stream and the background layer image data stream as the display data stream comprises:
blending, by the layer mixer circuit, the intermediate preblend image data stream and the background layer image data stream as the display data stream within a blending stage of a plurality of blending stages, wherein each blending stage corresponds to a memory access pipeline circuit of the plurality of memory access pipeline circuits; and
outputting, by the layer mixer circuit, the display data stream of each blending stage preceding a final blending stage of the plurality of blending stages as the background layer image data stream to a successive blending stage; and
outputting the display data stream to the display device comprises outputting, by the layer mixer circuit, the display data stream of the final blending stage of the plurality of blending stages to the display device.

24. The method of claim 23, further comprising:
receiving, by the layer mixer circuit, a memory access pipeline identifier and a blending stage indication for the first memory access pipeline circuit into a layer mixer configuration queue of a plurality of layer mixer configuration queues;
assigning, by the layer mixer circuit, a tag corresponding to the layer mixer configuration queue to the first memory access pipeline circuit based on the memory access pipeline identifier; and
responsive to receiving the intermediate preblend image data stream from the first memory access pipeline circuit, obtaining, by the layer mixer circuit, the memory access pipeline identifier and the blending stage indication from a top entry of the layer mixer configuration queue based on the tag;
wherein blending the intermediate preblend image data stream and the background layer image data stream as the display data stream within the blending stage of the plurality of blending stages is based on the blending stage indication.
